(19) United States
(12) Patent Application Publication
(10) Pub. No.: US 2021/0269369 A1
(43) Pub. Date: Sep. 2, 2021

(54) A METHOD FOR THE MANUFACTURE OF FOAMED PLASTER WITH HEMP

(71) Applicant: Edgar Donald Knott, Beckenham (AU)

(72) Inventor: Edgar Donald Knott, Beckenham (AU)

(21) Appl. No.: 17/258,703

(22) PCT Filed: Jul. 11, 2018
(86) PCT No.: PCT/AU2018/000103

§ 371 Date: Jan. 7, 2021

(51) Int. Cl. C04B 38/10; C04B 28/02; C04B 14/28; C04B 18/24; C04B 22/16; B01F 5/04; B01F 5/26; B01F 5/24; B01F 3/18; B01F 3/12; B01F 3/00; B28C 5/02; B28C 5/06; B28C 7/06; B28C 7/12; B28C 5/38; B28B 13/02; B28B 1/32

(52) U.S. Cl. CPC C04B 38/10; C04B 2103/408; C04B 14/28; C04B 18/248; C04B 22/165; B01F 5/0415; B01F 5/26; B01F 5/241; B01F 3/188; B01F 3/1271; B01F 3/0092; B28C 5/026; B28C 5/06; B28C 7/062; B28C 7/067; B28C 7/126; B28C 5/388; B28B 13/02; B28B 1/32; C04B 28/02

(57) ABSTRACT

A method for the manufacture of foamed plaster utilizing a mixture of powdered casting plaster, powdered limestone and hemp fibre. The mixture is fed into a Venturi apparatus (40) under the influence of gravity. Compressed air may be supplied to the Venturi apparatus (40) through an inlet pipe (41) causing air and solid particles to be sucked into the Venturi apparatus (40). The elongated tube is provided with an inlet nozzle arranged to receive a mixture of water mixed with detergent agents. Further, the tube (50) is provided with an inlet nozzle (56) arranged to receive compressed air such that the elongated tube (50) delivers the mixture to a mixing and spray head (60) so as to feed the resulting mixture to a moulding means.

### FIELD OF THE INVENTION

The present invention relates to a method for the manufacture of foamed plaster.

### BACKGROUND

The present invention attempts to overcome at least in part, the disadvantages of previously known methods for the manufacture of foamed plaster.

### SUMMARY OF THE INVENTION

It is known to provide foamed plaster for the manufacture of moulded components for use in industry. The present invention provides a new and improved method for manufacture of foamed plaster.

In accordance with one aspect of the present invention there is provided a method for the manufacture of foamed plaster which comprises feeding and mixing powdered casting plaster, powdered limestone and hemp from a supply thereof to a Venturi apparatus, then introducing the mixture to a supply of phosphoric acid, admixing the mixture and phosphoric acid, and forwarding the resulting mixture to a dispensing and spray head so as to feed the resulting mixture to a moulding means.

The use of a Venturi apparatus allows for improved feeding of material and reduces congestion observed in the prior art.

### BRIEF DESCRIPTION OF DRAWINGS

The present invention will now be described, by way of example, with reference to the accompanying drawing, in which:

FIG. 1 is a schematic diagram of an apparatus for putting the method of the present invention into practice.

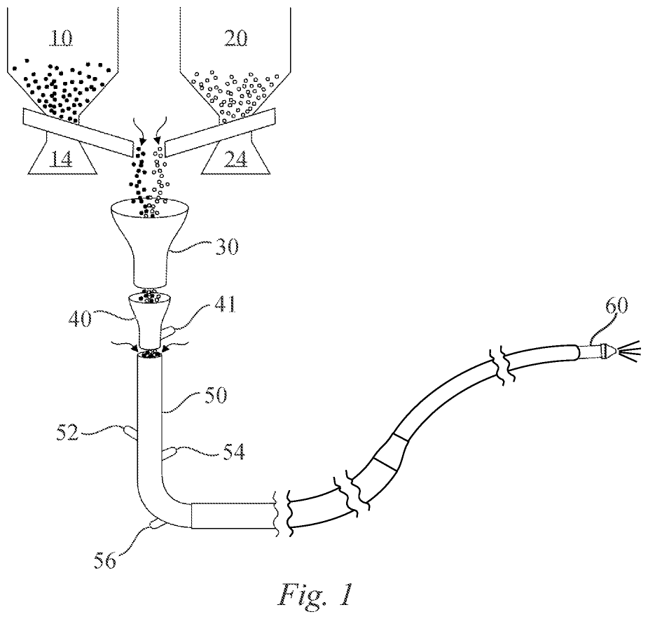

### DESCRIPTION OF PREFERRED EMBODIMENTS

As shown in the accompanying drawing, the present invention provides a method and apparatus comprising a first hopper (10) for a component material which feeds onto a first feeder (14) under the influence of gravity, and a second hopper (20) for a component material which feeds onto a second feeder (24) under the influence of gravity, wherein the component material fed into the first hopper (10) is powdered casting plaster and the component material fed into the second hopper (20) is a pre-mixed mixture of powdered limestone and hemp fibre.

The hemp fibre is preferably of Manila variety and less than 4 mm in length. Further, the use of hemp fibre is found to increase the strength of resultant products whilst keeping the weight down. For example, the resultant products may have a specific gravity of less than 0.4.

The first hopper (10) and second hopper (20) are provided with vibrating means to ensure a steady flow of component material to respective feeders (14/24) in use. The first feeder (14) and second feeder (24) are arranged in use to feed component material towards a third hopper (30).

The first feeder (14) and second feeder (24) are vibrating feeders of known type which are designed to provide a steady flow rate of component material to the third hopper (30) under the influence of gravity. The flow rate may be adjusted by means of a rheostat control.

The resulting mixture of the component materials, hereafter referred to as “the primary mixture (first stage)”, may consist of about 85 per cent by weight of casting plaster, about 4 per cent by weight of powdered limestone and about 11 per cent by weight of hemp fibre.

The third hopper (30) feeds the primary mixture (first stage) into a Venturi apparatus (40) under the influence of gravity. A gap maybe left between the outlet of the third hopper (30) and the inlet of the Venturi apparatus (40). The Venturi apparatus (40) may have multiple small holes in the casting. Compressed air is supplied to the Venturi apparatus (40) through an inlet pipe (41), causing air and solid particles to be sucked into the Venturi apparatus (40).

A gap maybe left between the outlet of the Venturi apparatus (40) and an elongated chemical tube (50). A primary mixture (first stage) becomes entrained in the air flow and flows through the Venturi apparatus (40) into the elongated chemical tube (50). The tube (50) may be formed of a suitable plastics material.

The elongated chemical tube (50) is provided with an inlet nozzle (52) arranged to receive dilute phosphoric acid. The phosphoric acid is sprayed into the elongated chemical tube (50) to combine with the primary mixture (first stage) to create a primary mixture (second stage). The dilute phosphoric acid is preferably 5% phosphoric acid supplied at a rate of about 7 litres per minute.

The elongated chemical tube (50) is provided with an inlet nozzle (54) arranged to receive a mixture of water mist with detergent agent. This mixture is sprayed into the elongated chemical tube (50) to combine with the primary mixture (second stage) to create a primary mixture (third stage). The water mist with detergent agent may be supplied at a rate of 1 litre per minute.

The elongated chemical tube (50) is provided with an inlet nozzle (56) arranged to receive compressed air. The compressed air is used to boost pressure through the elongated chemical tube (50). The elongated chemical tube (50) delivers the primary mixture (third stage) to a mixing and spray head (60). Typically, the operating pressure is 8 bar and provides free air capacity of about 50 cubic feet per minute.

Modifications and variations in which would be apparent to a skilled addressee are deemed to be within in the scope of the present invention. For example, a change in the reactivity of the plaster supplied may enable greater production and less time in the mould.

1-14. (canceled)

15. A method for the manufacture of foamed plaster which comprises,
mixing powdered casting plaster, powdered limestone and hemp from a supply thereof and feeding the mixture purely under the influence of gravity into a Venturi apparatus; then introducing the mixture from the Venturi apparatus to a supply of phosphoric acid, admixing the mixture and phosphoric acid, and forwarding the resulting composition to a dispensing and spray head so as to feed the resulting composition to a moulding means for production of a foamed plaster articles;
whereby the powdered casting plaster is fed through a first hopper, and the mixture of limestone and hemp is fed through a second hopper; and
whereby the Venturi apparatus is aligned substantially vertically.

16. A method for the manufacture of foamed plaster according to claim 1, wherein the mixture of powdered casting plaster, powdered limestone and hemp is fed through a third hopper into the Venturi apparatus.

17. A method for the manufacture of foamed plaster according to claim 2, wherein a gap is formed between the third hopper and the Venturi apparatus for allowing ingress of air.

18. A method for the manufacture of foamed plaster according to claim 1, wherein the mixture of powdered casting plaster, powdered limestone and hemp fed into the Venturi apparatus is 85 per cent by weight of casting plaster, 4 per cent by weight of powdered limestone and 11 per cent by weight of hemp.

19. A method for the manufacture of foamed plaster according to claim 1, wherein compressed air is supplied to the Venturi apparatus causing air and solid particles to be sucked into the Venturi apparatus.

20. A method for the manufacture of foamed plaster according to claim 1, wherein the Venturi apparatus is connected to the dispensing and spray head via a tube.

21. A method for the manufacture of foamed plaster according to claim 1, wherein the phosphoric acid is dilute 5% phosphoric acid supplied at a rate of 7 litres per minute.

22. A method for the manufacture of foamed plaster according to claim 1, wherein a mixture of water mist with detergent agent is introduced into the plaster mixture, and wherein the mixture of water mist with detergent agent is supplied at a rate of 1 litre per minute.

23. A method for the manufacture of foamed plaster according to claim 1, wherein the hemp is equal to or less than 4 mm in length.

24. A method for the manufacture of foamed plaster according to claim 1, wherein each hopper has a respective lower aperture and is provided with vibratory means to facilitate release of the powdered material under the influence of gravity so as to form a mixture in a third hopper below the first and second hoppers.
